(19) United States
(12) Patent Application Publication
(10) Pub. No.: US 2024/0401661 A1
(43) Pub. Date: Dec. 5, 2024

(54) SYSTEMS AND METHODS FOR DAMPING VIBRATIONS

(71) Applicant: Theodore Stack, Devon (GB)

(72) Inventor: Theodore Stack, Devon (GB)

(21) Appl. No.: 18/676,183

(22) Filed: May 28, 2024

Related U.S. Application Data
(60) Provisional application No. 63/470,900, filed on Jun. 4, 2023.

(51) Int. Cl. F16F 7/01

(52) U.S. Cl. CPC F16F 7/01; F16F 2224/0208; F16F 2230/30

(57) ABSTRACT

The present disclosure combines a particle impact damping (PID) chamber with an elastomer damping (ED) component (also referred to as a block) in an assembly to dampen vibration when placed under a piece of hi-fi equipment. According to an aspect of the present invention, there is provided an assembly for damping vibration comprising a main body defining a first cavity and a second cavity, a plurality of particle impact dampers contained within the first cavity of the main body; and an elastomer damper contained within the second cavity.

### CROSS-REFERENCE TO RELATED APPLICATIONS

This non-provisional patent application claims the benefit of U.S. Provisional Application No. 63/470,900 filed on Jun. 4, 2023, the entirety of which is incorporated herein by reference.

### FIELD

The present disclosure relates generally to damping vibrations. More particularly, the present disclosure relates to assemblies, systems, and methods to damp vibrations in a sound system. In particular, the present disclosure relates to combining particle impact damping (PID) with elastomer damper (ED) in a single assembly to damp vibration in a high fidelity (hi-fi) sound system for generating music.

### BACKGROUND

The prior art patent literature includes a number of systems and methods for damping vibrations.

For example, U.S. Pat. No. 5,855,353 discloses a method and apparatus of damping vibration or sound in a vibrating mechanical system such as an appliance comprising the steps and features of providing a constraining layer, providing an adhering layer which includes a viscosity enhancing material and an adhesive material and adhering the constraining layer to a surface of the mechanical system with the adhering layer. The adhering layer can be a composite of an adhesive layer such as a viscoelastic adhesive material with a viscosity enhancing material in the form of, for example, cellulose fibers. Such cellulose fibers can be wetted with an adhesive which penetrates the fiber carrier sheet at least to some degree.

U.S. Pat. No. 10,708,678 discloses a device including a loudspeaker body, a loudspeaker fastener structure, and a loudspeaker shock absorption structure, the loudspeaker absorption structure including a first elastomer, a second elastomer, and a bridging beam, wherein the first elastomer is connected to the second elastomer by the bridging beam, the first elastomer is connected with the loudspeaker body, the first elastomer is configured with an annular groove, the loudspeaker body is configured with a snap ring matching the annular groove, and the snap ring is clamped with the annular groove, wherein the second elastomer is connected with the loudspeaker fastener structure, the second elastomer is configured with a through hole, the loudspeaker fastener structure is configured with a connecting post matching the through hole, and the connecting post passes through the through hole of the second elastomer, and wherein the bridging beam is configured with a first opening and a second opening.

However, prior art systems and methods suffer from limitations including lack of ability to enhance the quality of hi-fi music. There is a need for an assembly, system or method that would damp vibrations for hi-fi sound or music.

### SUMMARY OF INVENTION

Therefore, according to an exemplary arrangement, an assembly for damping vibration comprises a main body defining a first cavity and a second cavity, a plurality of particle impact dampers contained within the first cavity of the main body; and an elastomer damper contained within the second cavity.

In one arrangement, the first cavity defines a ring-shaped cavity containing the particle impact dampers.

In one arrangement, the first cavity is sealed with a metal plate.

In one arrangement, the main body comprises a machined metal body.

In one arrangement, the main body comprises an aluminum main body.

In one arrangement, the main body comprises a stainless-steel main body.

In one arrangement, the particle impact dampers comprise stainless steel dampers. In one arrangement, the particle impact dampers comprise a particle size ranging from about 0.0001 millimetres to about 5.0 millimetres.

In one arrangement, the assembly comprises an assembly for damping vibration in a sound system.

In one arrangement, the first cavity defines a first volume and the second cavity defines a second volume, wherein the second volume is greater than the first volume.

In one arrangement, the main body defines a threaded aperture.

In one arrangement, the elastomer damper threadedly engages the threaded aperture defined by the main body.

In one arrangement, the assembly further comprises a metal plate operably coupled to a first surface of the elastomer damper, wherein the metal plate threadedly engages the threaded aperture defined by the main body.

In one arrangement, the elastomer damper comprises an elastic material.

In one arrangement, the elastic material comprises silicone.

In one arrangement, the elastomer damper comprises a cylindrically shaped damper.

In one arrangement, the main body defines a first surface, wherein the first surface is provided with a rubber insulator.

In one arrangement, the elastomer damper defines a second surface, wherein the second surface comprises a concave surface.

In one arrangement, the elastomer damper defines a plurality of apertures extending between the concave surface and an outer surface of the elastomer damper, enabling it to act as an air spring.

In one arrangement, the assembly further comprising a third cavity, wherein the third cavity is positioned in between the first cavity and the second cavity.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of one or more illustrative embodiments of the present disclosure when read in conjunction with the accompanying drawings, wherein:

FIG. 1 illustrates a particle impact damping (PID) chamber with an elastomer damping (ED) component (also referred to as a block) in an assembly to damp vibration;

FIG. 2 illustrates another perspective view of the assembly for damping vibration illustrated in FIG. 1;

FIG. 3 illustrates a main body of the assembly;

FIG. 4 illustrates an elastomer damper;

FIG. 5 illustrates an alternative perspective view of the main body;

FIG. 6 illustrates a side view of the elastomer damper of FIG. 4;

FIG. 7 illustrates a perspective view of the elastomer damper of FIG. 4;

FIG. 8 illustrates another perspective view of the elastomer damper of FIG. 4;

FIG. 9 illustrates a cut-away view of the assembly for damping vibration illustrated in FIG. 1; and

FIG. 10 illustrates a perspective view of a hi-fi or stereo system utilizing an assembly for damping vibration, such as the assembly illustrated in FIGS. 1 and 2.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Components of a high-fidelity sound system frequently vibrate. Such vibration may come, for example, from mechanical components of a sound system. Additional or alternatively, vibration may also come from a surface that sound system components are resting on. Unwanted vibration may also come from other objects not related to the sound system.

A high-fidelity system, also known as high fidelity audio, or hi-fi audio, is audio that is very high quality. The factors that play into this level of quality are a high accuracy at reproducing the audible frequencies in an audio recording, with limited distortion in the original audio signal. Hi-fi has been described as sounding clear, clean, crisp, and free from distortion and other unwanted sonic artifacts. This in general is what high fidelity or “hi-fi” means.

Vibrations affect the nature and quality of audio reproduction. Vibrations from loudspeaker cabinets can cause echoes, timing smears and a reduction in clarity of the audible sound signal, impairing the accurate reproduction of the music. Vibrations, when transmitted through room structures like floors or walls, can cause such structures to emit secondary sound radiations or resonances, interfering with the primary audio signal. Controlling and damping these vibrations in source and electronic components as well as loudspeakers is important to preserving the true essence and quality of hi-fi audio playback.

A vinyl record player or turntable works in part by measuring the sound waves that are recorded physically in the sides of the record groove via a stylus/tonearm that tracks the groove as the record rotates. The stylus on the end of the cartridge cantilever moves with the undulations in the groove and transmits this movement mechanically to the cartridge which converts it into a low-level electrical signal. This movement can be thought of as a vibration induced by the shape of the record groove as it rotates under the stylus. The electrical signal is sent via a cable to the amplifier(s) in the hi-fi system which in turn passes it to the speakers that convert it back into audible sound waves.

To perform at a very high level, the cartridge's stylus should pick up only those vibrations that are caused by the undulations contained in the record groove. In practice, this has been a challenging endeavor. Other sources of vibration often find their way through the record player's structure and affect the stylus. Undesired or unwanted vibrations that are not from the stylus acting in the record groove represent unwanted noise and/or distortion.

Vibration that adds distortion to the turntable comes from (but is not limited to): a) internal vibration from the turntable bearings and the motor; b) external pressure waves generated by the loudspeakers and transmitted through the room walls and floors; c) external room vibrations and sound waves; d) other electrical appliances, such as dishwashers, clothes washers, clothes dryers, refrigerators, and the like; and e) outside traffic, noise from outside construction, and the like. Most of the external vibration that needs to be removed is low frequency vibration which comes from speakers. However, vibrations within a turntable affects the sound and can affect the longevity of the apparatus.

Vibration in loudspeakers may also cause distortion of the desired hi-fi audio. A common type of hi-fi loudspeaker is the dynamic driver design. This design works in part by using an electrical current from the amplifier to move a voice coil held in place in a permanent magnetic field. The voice coil is attached to a diaphragm that moves back and forth creating the soundwaves. The speaker drivers are mounted in a cabinet of housing. There are many different types of drivers, configurations, and cabinet/housing designs which work on the same basic principle.

The soundwaves (which comprise vibrations and energy) ideally will excite only the air rather than the body of the speaker and the floorboards, furniture, walls, and the like. However, what also happens is that the energy travels down the speaker cabinet/housing (and speaker stand if used) into the floor and the furniture. This then makes the room and surrounding structures, such as, for example but not by way of limitation, floorboards, walls, furniture, act as radiating surfaces which distorts the audible soundwaves and creates vibrations that effect the other hi-fi components (turntable and electronics) creating electronic and digital noise degrading the audio signal. Noise can also enter the speaker from external sources such as white goods, traffic noise, and the like.

Other electronic components can also cause unwanted vibration and are susceptible to external vibrations. Electrical audio equipment, for example, but not by limitation, CD players, digital sources, tuners, amplifiers, and the like, also suffer from vibration induced distortion, known as microphony. Vacuum tubes, crystal oscillators (clocks), capacitors and other electrical components used inside these units are also susceptible. This includes certain types of digital devices such as CD players, music streamers, PCs and laptops, since they rely on digital clocks and other components which are exposed to microphony such that vibration creates electrical interference that creates jitter (unwanted digital noise and timing errors).

The presently disclosed embodiments for assemblies to damp vibrations in hi-fi equipment comprise two separate vibration damping technologies working together in each unit (or isolation foot). These are particle impact damping (PID) and decoupling using elastomer damping (ED).

Particle impact damping (PID) is a technology that employs particles held within a confined space or chamber that collide with each other and the chamber walls when subjected to vibrations. The collisions dissipate the vibrational energy by turning it into heat. As the vibrations affecting a hi-fi system are complex and multi-axis in nature, the shape of the PID chamber(s) within the embodiments are designed to optimize vertical contact for vertical vibrations and horizontal contact for horizontal vibrations.

There are times during a cycle when particles move separately from the enclosure, and some other times they move in contact with the enclosure. An effective coefficient of restitution gives a measure of how much energy dissipation occurs due to inelastic collisions and frictional sliding amongst the particles, and between the particles and the enclosure walls.

The particles may be formed in a preferred embodiment from at least one of stainless steel, carbon steel, iron, tungsten, glass, and ceramic. In one preferred arrangement, the particles comprise a particle size of about 0.0001 millimeters to about 5.0 millimeters. Many other particle materials can be used, among them lead spheres and sand. The weight of the moving particles inside the PID can be for example approximately 10% the mass of the assembly.

Differences may be due to the difference in material properties of each particle that govern the energy dissipation mechanism. Damping may increase as material density of the particles increases. There could be more factors other than material properties that cause the difference in damping, such as how the particles travel during vibration, e.g., whether as a lumped mass or as a cloud.

In one preferred arrangement, elastomer damping (ED) uses an elastic material as a vibration absorber providing decoupling between the equipment and the support shelf. An air space between the shelf and the elastomer damper is formed by the concave lower surface of the damper that facilitates springing movement. Apertures through the side walls of the damper allow the passage of air, increasing compliance and absorbing more vibration.

Three or four of these isolation feet incorporating both vibration damping technologies could be placed under each piece of electrical audio equipment or turntable that needs support.

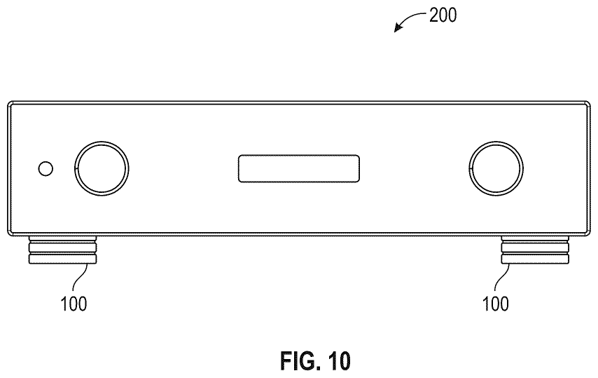

In one preferred arrangement, the present disclosure will be used in a height adjustable vibration isolation foot for hi-fi or stereo equipment placed on racks, shelves, and platforms. In a typical usage case, 3 or 4 of the feet would be placed underneath hi-fi equipment such as CD players, DACs, network streamers, phono amplifiers, pre-amplifiers, power amplifiers, integrated amplifiers, tuners, integrated streamer/amplifier combinations and turntables (as illustrated in FIG. 10).

The present disclosure combines a particle impact damping (PID) chamber with an elastomer damping (ED) component (also referred to as a block) in an assembly to dampen vibration when placed under a piece of hi-fi equipment. This assembly can be referred to as a ‘PID/ED hi-fi equipment isolator’.

In one arrangement, the PID/ED hi-fi equipment isolator comprises a machined outer metal body enclosing a single ring-shaped chamber containing particles for PID with a larger open cavity below containing the ED component. In one arrangement, there is a threaded hole drilled into the center at the top of the metal body surrounded by the PID chamber. In one preferred arrangement, the machined body comprises an aluminum or stainless-steel body.

In one preferred arrangement, the PID chamber contains a plurality of particles that turn the kinetic energy from vibrations into heat through movement and collisions. This is generally an underlying principle of particle impact damping and is known to those of ordinary skill in the relevant art. In one preferred arrangement, the PID chamber may be sealed and/or enclosed with a fixed metal plate.

In one preferred arrangement, an ED block is removably or non-removably attached to a metal plate and/or a threaded bolt. In this preferred arrangement, this metal plate and threaded bolt may be screwed into the machined outer metal body. As just one example, there may be approximately about 2-5 mm adjustment height available on the threaded bolt so as to allow for height adjustment and levelling as desired.

In one preferred arrangement, the ED block comprises silicone, a synthetic viscoelastic urethane polymer used as a shock absorber and vibration damper (such as Sorbothane) or other similar types of elastic material. As just one example, the ED block may be molded into a cylindrical shape so as to fit inside the metal case with space between the case and the ED block.

In one preferred arrangement, the top surface of the ED block is flat and is rigidly affixed (e.g., glued) to the metal plate with the threaded bolt that screws into the outer machined metal body.

In one preferred arrangement, a lower half of the ED block features an open dished cavity with a plurality (e.g., 4) apertures or holes running from the cavity to the outside edge of the block. This is to allow for compression of the ED block and the movement of air between the ED cavity and the space between the block and the outer machined metal body. According to one preferred assembly, the ED block makes direct contact with the surface (e.g., a rack, shelf or platform) that supports the hi-fi equipment. In such an arrangement, the hi-fi equipment may rest directly on the top surface of the outer machined metal body.

As constructed, a proposed combination of particle impact damping (PID) and elastomer damping (ED) provides vibration absorption over a wide frequency range for hi-fi equipment that does not have to be held rigidly.

As constructed, the ED block absorbs external vibrations transmitted up through the rack or shelf and prevents these vibrations from entering the hi-fi equipment. This vibration is typically generated by loudspeaker sound waves and room/floor resonances as well as external vibrations that affect the hi-fi listening room.

The PID chamber absorbs vibrations coming from the hi-fi equipment's case. This could be generated internally by, for example, power supplies or has been transmitted by air-borne sound waves.

The threaded bolt allows the elastomer block to be adjusted for height within the machined metal body allowing height and level adjustments of the hi-fi equipment.

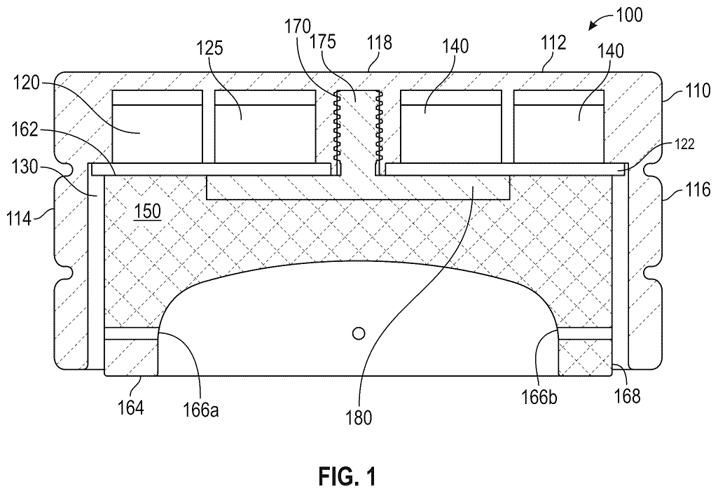

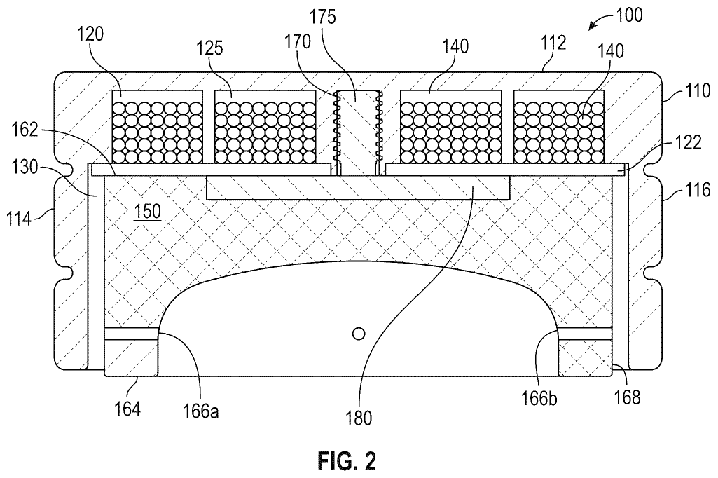

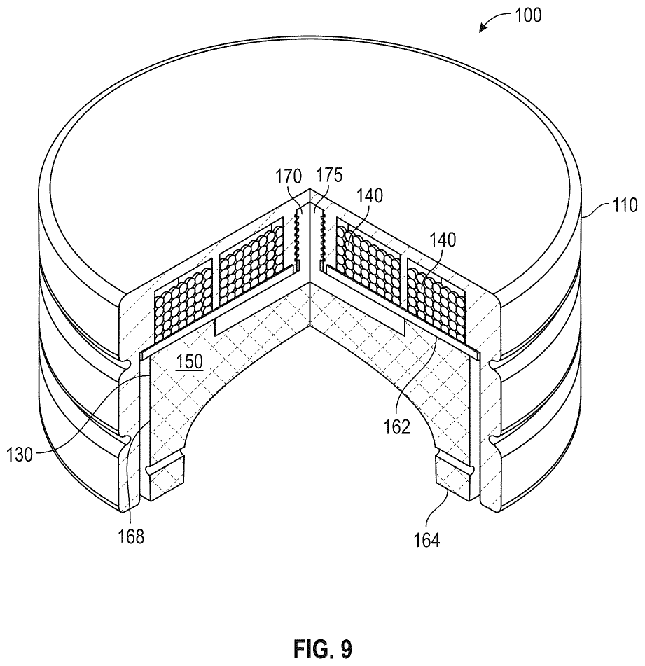

Referring now to the figures, FIG. 1 illustrates a perspective view of an assembly 100 for damping vibration. FIG. 2 illustrates another perspective view of the assembly 100 for damping vibration illustrated in FIG. 1. And FIG. 9 illustrates a cut away view of the assembly for damping vibration illustrated in FIGS. 1 and 2. Referring now to FIGS. 1, 2, and 9, in one arrangement, the assembly 100 comprises an assembly for damping vibration in a sound system. However, as those of ordinary skill in the art will recognize, the disclosed assemblies, systems and methods may be applied in alternative vibration damping uses.

### Main Body

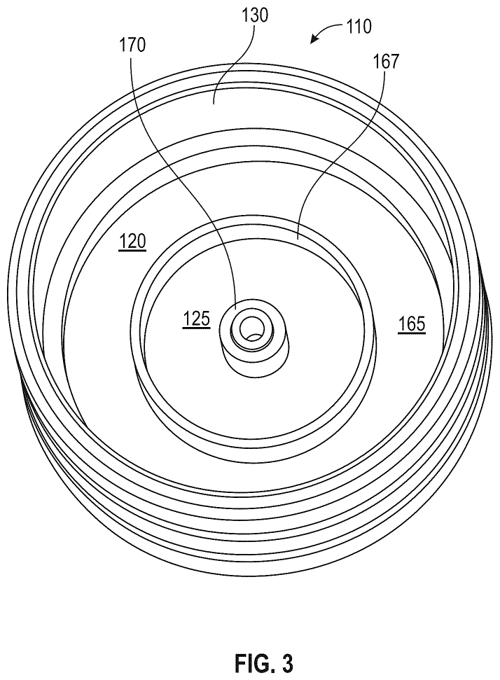

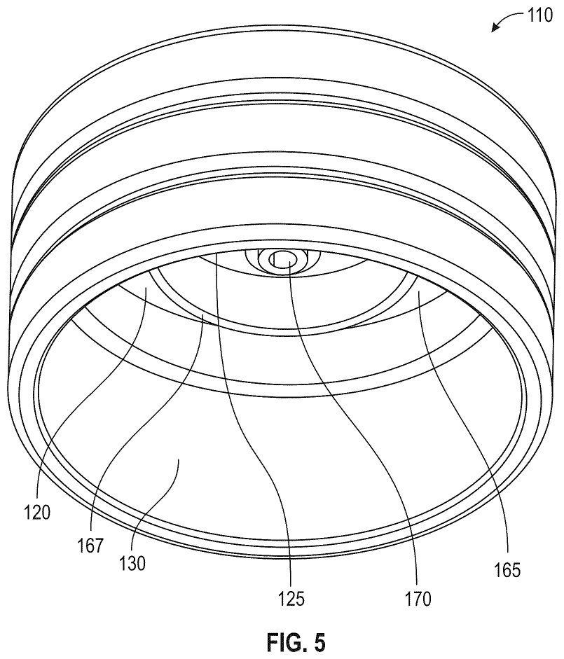

According to an exemplary arrangement, this assembly 100 for damping vibration comprises a main body 110. For example, FIGS. 3 and 5 illustrate perspective views of the main body 110 illustrated in FIGS. 1, 2, and 5. In one preferred arrangement, this main body 110 comprises a top or first surface 112 that extends between a first wall 114 and a second wall 116. The first wall 114 and the second wall 116 defining a cylindrical structure. In one arrangement, the first surface 112 of the main body 110 is provided with a rubber insulator 118 (FIG. 1). For example, in one preferred main body arrangement, the first surface 112 of main body 110 is machined in order to receive this rubber insulator 118.

FIGS. 3 and 5 provide alternative perspective views of the main body 110. As can be seen from FIGS. 3 and 5, the main body 110 further comprises an inner surface 165. This inner surface 165 comprises a threaded aperture 170 extending from the first surface 165 and a ring 167 also extending from this inner surface 165.

As illustrated, the main body 110 is configured to define both a first cavity 120, a second cavity 125, and a third cavity 130. For example, FIGS. 3 and 5 illustrate a bottom view of the main body 110 illustrated in FIGS. 1 and 2.

In one arrangement, the main body 110 comprises a machined metal body. As just one example, this machined main body 110 may comprise an aluminum main body or alternatively a stainless-steel main body. However, as those of ordinary skill in the art will recognize, alternative main body materials may also be used such as wood, ceramic, and other similar materials.

In one arrangement, the first cavity 120 of the main body 110 defines a first ring-shaped or a doughnut shaped cavity 120 for containing a plurality particle impact dampers 140. In one arrangement, the first cavity 120 may be sealed with a metal plate 122. In one preferred arrangement, the first cavity 120 is sealed with a metal plate 122. In an alternative arrangement, the first cavity 120 may or may not be configured to receive a container containing a plurality of particle impact dampers, substantially similar to the plurality of particle impact dampers 140 as herein described.

In one arrangement, the second cavity 125 of the main body 110 defines a second ring-shaped or a doughnut shaped cavity 125 for containing a plurality particle impact dampers 140. In one arrangement, the second cavity 125 may or may not be sealed with the metal plate 122. In an alternative arrangement, the second cavity 125 may be configured to receive a container containing a plurality of particle impact dampers, substantially similar to the plurality of particle impact dampers 140 used to fill the first cavity 120.

In one arrangement, the first cavity 120 substantially defines a first volume and the second cavity 125 defines a second volume. The assembly 100 may be configured with various first and second cavity arrangements. For example, in one arrangement, the second volume of the second cavity 125 may be greater or may be larger than the first volume of the first cavity 120. In an alternative arrangement, the first and second volumes may be substantially similar.

In one arrangement, the first cavity 120 substantially defines a first volume, the second cavity 125 defines a second volume, and the third cavity 130 defines a third volume. The assembly 100 may be configured with various first, second, and third cavity arrangements. For example, in one arrangement, the second volume of the second cavity 125 may be greater or may be larger than the first volume of the first cavity 120. In an alternative arrangement, the first and second volumes may be substantially similar, or they may be larger or smaller than the third volume.

In an alternative assembly arrangement, the assembly 100 may further comprise a fourth cavity. For example, such a fourth cavity may be positioned in between the first cavity 120 and the second cavity 125. In another example, such a fourth cavity may be positioned in between the first cavity 120 and the third cavity 130. This fourth cavity may be configured to contain additional particle impact dampers, substantially similar to the particle impact dampers 140 illustrated in FIGS. 1, 2, and 9. In an alternative arrangement, this fourth cavity may be configured to contain an elastomer damper, substantially similar to the damper 150 illustrated in FIGS. 1, 2 and 9.

### Particle Impact Dampers

As illustrated, the assembly 100 includes a plurality of particle impact dampers 140 and these particle impact dampers 140 are fixedly contained within the first cavity 120 and the second cavity 125 of the main body 110. These particle impact dampers 140 may all comprise the same sized particle impact dampers. In an alternative arrangement, these impact dampers 140 may comprise different sized particle impact dampers. As just one example, in one arrangement, the particle impact dampers 140 comprise stainless steel dampers. In one arrangement, the particle impact dampers 140 comprise a particle size ranging from substantially about 0.0001 millimeters to substantially about 5.0 millimeters. As those of ordinary skill in the art will recognize, alternative sized particle impact dampers 140 may also be used.

Multiple PID chambers or container embodiments enhance responsiveness. That is, with the particles being more easily excited due to reduced inertia, the chambers or containers can be more responsive to a wider range of vibration intensities. A smaller force will be sufficient to cause meaningful particle-wall interactions in these chambers.

Multiple chamber arrangements also provide for increased surface interactions. When particles are distributed across multiple chambers, there are more particle-wall interactions in each chamber.

### Elastomer Damper

As also illustrated in FIGS. 1, 2, and 9, the assembly 100 comprises an elastomer damper 150 and this elastomer damper 150 may be configured to be contained and/or enclosed within the third cavity 130. For example, in one arrangement, the elastomer damper 150 may comprise a generally cylindrical main body having a first surface and a second surface wherein the second surface is substantially parallel to the first surface. The generally cylindrical main body further comprises a first wall and a second wall, both first and second walls extending between the first surface and the second surface. However, as those of ordinary skill in the art will recognize, other main body configurations may also be utilizes such as rectangular, hexagon, and other similar structures.

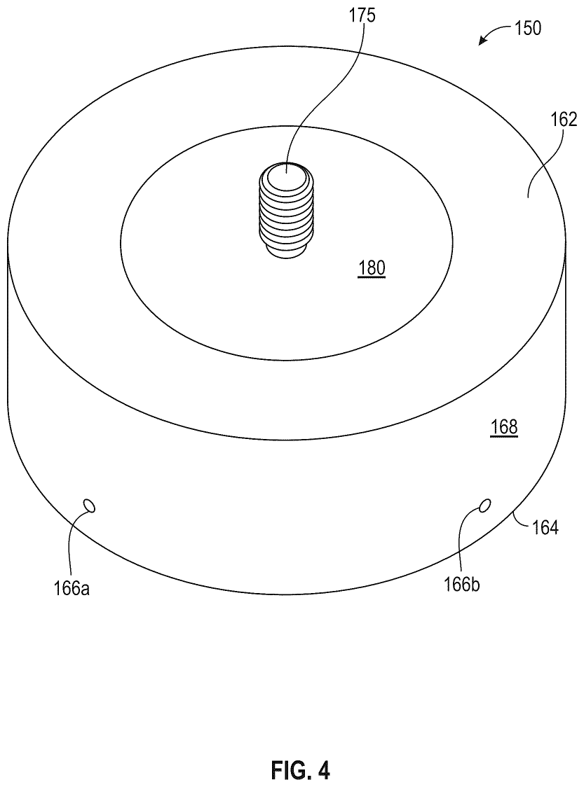

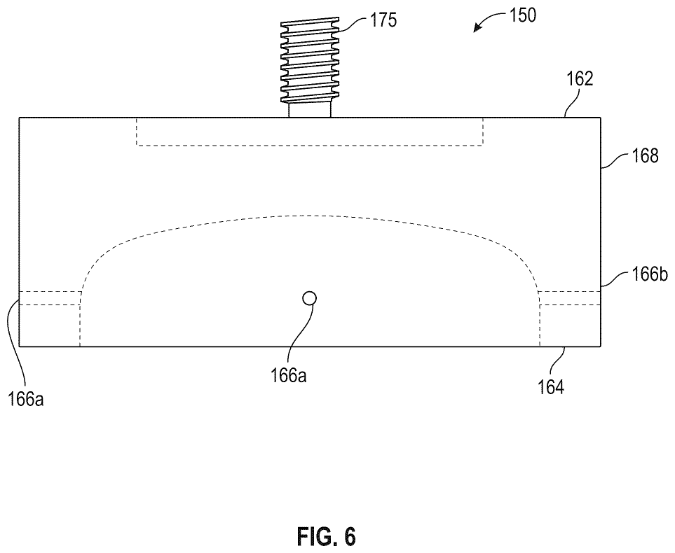

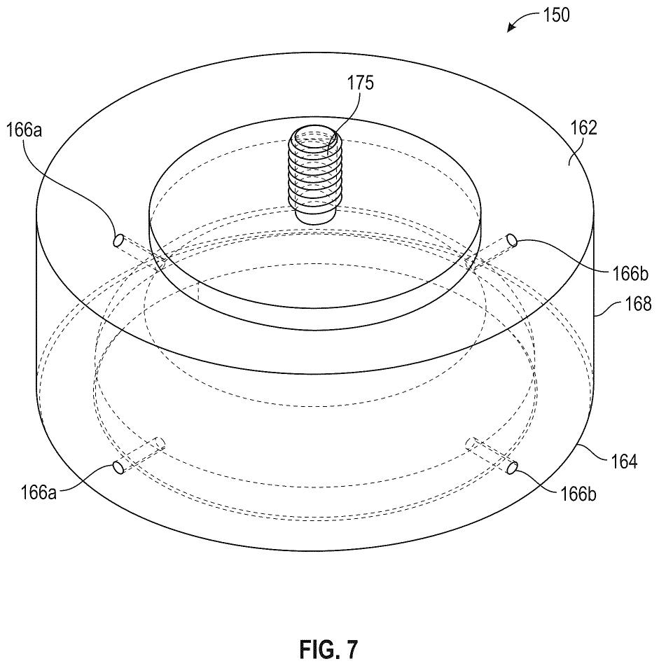

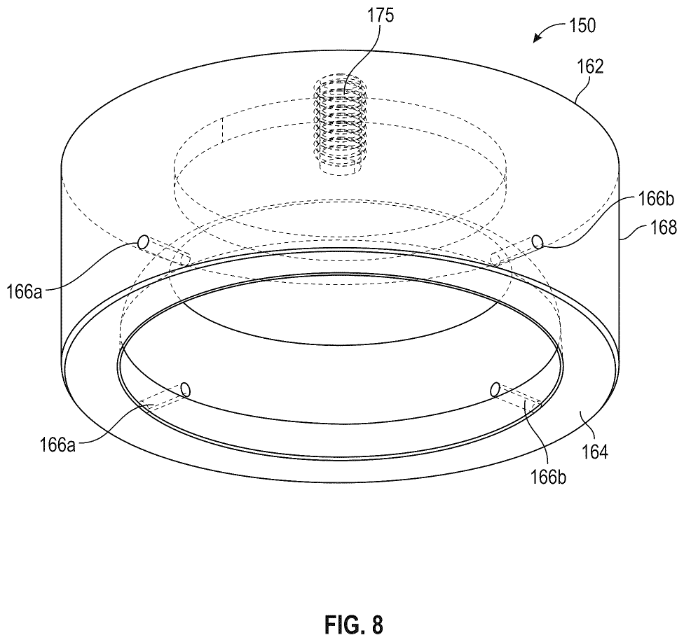

In this illustrated arrangement, the assembly 100 illustrated in FIGS. 1, 2, and 9 comprises an elastomer damper 150. For example, FIGS. 4, 6, 7, and 8 illustrate perspective views of this elastomer damper 150. Turning to the assembly 100 illustrated in these figures, the elastomer damper 150 comprises a generally cylindrical main body having a first surface 162 and a second surface 164. In this arrangement, the elastomer damper 150 defines a second surface 164, wherein the second surface 164 comprises a substantially concave surface. As also illustrated in FIGS. 1, 2, 6 and 8, the elastomer damper 150 is configured to define a plurality of apertures 166a, 166b extending between the concave surface 164 and an outer surface 168 of the elastomer damper 150. In one preferred arrangement, the elastomer damper 150 comprises four apertures 166a, 166a, 166b, and 166b extending between the concave surface 164 and the outer surface 168 of the alternative elastomer damper 169 (FIGS. 7 and 8). These apertures serve to allow the elastomer damper to act as an air spring allowing the passage of air between the space enclosed by the surface 164 and the external surface or shelf the damper is sitting on and the space between the elastomer damper 160 and the wall of the second cavity 130 in the main body thereby increasing compliance and absorbing more vibration. The lower surface 164 of the damper protrudes beyond the lower edge of the main body 110 allowing the air to escape between the damper assembly 100 and the surface it is resting on. However, as those of ordinary skill in the art will recognize, alternative elastomer damper aperture arrangements and/or aperture configurations may be utilized.

In one arrangement, the elastomer damper 150 illustrated in FIGS. 4, 6, 7 and 8 comprise an elastic material. For example, the elastic material may comprise silicone or other similar like compressible material. In a preferred arrangement, the elastomer damper 150 is configured to reside within the third cavity 130 defined by the main body 110. As just one example, the elastomer damper 150 may comprise a cylindrically shaped damper in order to fit within a cylindrically shaped second cavity defined by the main body 110.

In one arrangement, the main body 110 further defines a threaded aperture 170 (FIGS. 1-3) extending from the inner surface 165. As illustrated, this threaded aperture 170 may be defined in a central portion of the main body 110 and is generally configured to receive a threaded member 175. In one arrangement, the elastomer damper 150 threadedly engages the threaded aperture 170 defined by the main body 110. For example, in one arrangement (FIG. 4), the assembly 100 may further comprise a metal plate 180 that is inserted or operably coupled to the first surface of the elastomer damper. In this manner, the metal plate 180 threadedly engages the threaded aperture 170 defined by the main body 110.

In an alternative arrangement, the elastomer damper 150 may be configured to comprise a threaded member 175 which threadedly engages the threaded aperture 170. As those of ordinary skill in the art will recognize, alternative threaded member configurations may also be utilized.

FIG. 10 illustrates a perspective view of a hi-fi or stereo system 200 utilizing an assembly for damping vibration, such as the assembly 100 illustrated in FIGS. 1 and 2. As illustrated, the assemblies are placed under the hi-fi or stereo system and can be attached via a screw or similar attachment mechanism. In one preferred arrangement, the assembly for damping vibration is used in a height adjustable vibration isolation foot for hi-fi or stereo equipment placed on racks, shelves, and platforms. In a typical usage case, 3 or 4 of the feet would be placed underneath hi-fi equipment such as CD players, DACs, network streamers, phono amplifiers, pre-amplifiers, power amplifiers, integrated amplifiers, tuners, integrated streamer/amplifier combinations and turntables.

The integration of Particle Impact Damping (PID) with Elastomer Damping (ED) in a single assembly presents a novel approach to vibration control in high-fidelity (hi-fi) sound systems. This combination harnesses the strengths of both technologies to create an unparalleled vibration damping solution, crucial for maintaining the integrity of sound quality in hi-fi systems.

PID technology utilizes particles within a confined space that absorb and dissipate energy when subjected to external vibrations. As the system encounters vibrational forces, these particles shift and collide, effectively converting kinetic energy into heat and thereby reducing the amplitude of vibrations. This process is particularly effective for high-frequency vibrations, which are common in the operational environment of hi-fi systems, such as the hi-fi system illustrated in FIG. 10.

In one arrangement, ED employs a soft, often viscoelastic material that deforms under stress, providing absorption of low-frequency vibrations. The elastomer nature of elastomers allows them to change shape and return to their original form, a property that can be important for absorbing and isolating vibrations over a wide range of frequencies. This characteristic helps to ensure that the sound quality is not compromised by external disturbances that could otherwise cause distortions.

In this illustrated arrangement, when PID and ED are combined in a single assembly, the result is a synergistic effect that enhances the vibration damping capabilities beyond what each technology can achieve independently. The PID system can be fine-tuned to target specific vibrational frequencies, while the ED provides a broad-spectrum base that supports and extends the effectiveness of the PID. This dual-action approach ensures that a wide range of vibrational frequencies are addressed, preserving the clarity and richness of the music produced by the hi-fi system.

Moreover, mounting such a combined damping system to the bottom of a hi-fi stereo can significantly improve the acoustic performance. The strategic placement allows for direct interception of vibrational energy from the surface on which the stereo rests, which is often a primary source of unwanted vibrations. By mitigating these vibrations at the point of contact, the damping system prevents them from ever reaching the sensitive components of the stereo, thereby protecting the integrity of the sound output.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The arrangement, arrangements, embodiment, or embodiments selected are chosen and described in order to best explain the principles of the embodiments, the practical application, and to enable others of ordinary skill in the art to understand the disclosure for various embodiments with various modifications as are suited to the particular use contemplated.

I claim:

1. An assembly for damping vibration, the assembly comprising:
a main body containing a first cavity and a second cavity, wherein the main body is separated from hi-fi equipment by an air space;
a particle impact damping (PID) chamber containing a plurality of particles within the first cavity of the main body; and
an elastomer damping block contained within the second cavity.

2. The assembly of claim 1, wherein the first cavity defines a ring-shaped cavity containing the particle impact dampers.

3. The assembly of claim 1, wherein one or more of the first cavity and the second cavity are sealed with a metal plate.

4. The assembly of claim 1, wherein the main body comprises a machined metal body.

5. The assembly of claim 1, wherein the main body comprises an aluminum main body.

6. The assembly of claim 1, wherein the main body comprises a stainless-steel main body.

7. The assembly of claim 1, wherein the particles comprise one or more of steel, iron, tungsten, glass, and ceramic.

8. The assembly of claim 1, wherein the particle impact dampers comprise a particle size ranging from about 0.0001 millimeters to about 5.0 millimeters.

9. The assembly of claim 1, wherein the assembly comprises an assembly for damping vibration in a sound system.

10. The assembly of claim 1, wherein the first cavity defines a first volume and the second cavity defines a second volume, wherein the second volume is substantially greater than the first volume.

11. The assembly of claim 1, wherein the main body comprises a threaded aperture.

12. The assembly of claim 11, wherein the elastomer damper threadedly engages the threaded aperture defined by the main body.

13. The assembly of claim 12, further comprising a metal plate operably coupled to a first surface of the elastomer damper.

14. The assembly of claim 1, wherein the elastomer damper comprises an elastic material.

15. The assembly of claim 15, wherein the elastic material comprises one or more of silicone and another viscoelastic material.

16. The assembly of claim 1, wherein the elastomer damper comprises a cylindrically shaped damper.

17. The assembly of claim 1, further comprising a rubber insulator.

18. The assembly of claim 1, wherein the elastomer damper defines a second surface, wherein the second surface comprises a substantially concave surface.

19. The assembly of claim 18, wherein the elastomer damper defines a plurality of apertures extending between the substantially concave surface and an outer surface of the elastomer damper.

20. The assembly of claim 1, further comprising a third cavity, wherein the third cavity is positioned in between the first cavity and the second cavity.
